(19) United States
(12) Patent Application Publication
(10) Pub. No.: US 2008/0238722 A1
(43) Pub. Date: Oct. 2, 2008

(54) Parking Aid for a Vehicle and Parking Aid Method

(76) Inventors: Heinrich Gotzig, Heilbronn (DE); Raoul Leumalieu-Pagop, Bietigheim-Bissingen (DE)

Correspondence Address: DREISS, FUHLENDORF, STEIMLE & BECKER, POSTFACH 10 37 62, D-70032 STUTTGART, DE

(21) Appl. No.: 11/667,171

(22) PCT Filed: Nov. 4, 2005
(86) PCT No.: PCT/EP2005/011857

§ 371 Date: Nov. 13, 2007

(30) Foreign Application Priority Data
Nov. 8, 2004 (DE) 10 2004 055 372.6

(51) Int. Cl. B60Q 1/48

(52) U.S. Cl. 340/932.2

(57) ABSTRACT

A parking aid (10) comprises at least one sensor (12) emitting and/or receiving signals, and an evaluation unit (18) processing the emitted and/or received signals. The parking aid is characterized in that a deflection device (22) swivels the sensor (12) and/or the emission direction (16) of the sensor depending on the emitted and/or received signals. A corresponding parking aid method is also described.

The invention concerns a parking aid for a vehicle, comprising at least one sensor that emits and/or receives signals, and an evaluation unit that processes the emitted and/or received signals.

There are a variety of conventional parking aids of this type.

Parking aids of this type are disclosed e.g. in DE 102 57 722 A1 or DE 102 45 421 A1. In prior art, the length of a parking space is detected using sensors which are disposed on the side of the vehicle. The sensors thereby radiate substantially in a direction which is perpendicular to the travelling direction of the vehicle.

It has thereby turned out that conventional parking aids cannot determine the exact length of a parking space, since it is not possible to precisely detect the objects or object contours that delimit the parking space.

It is therefore the underlying purpose of the present invention to provide a parking aid and a parking aid method, which permit precise detection of the contours of objects detected by the sensors. The invention is thereby not limited to determining the length of a gap between two objects, but should, in general, be suited to detect the contours of objects that the vehicle passes, with maximum precision.

This object is achieved by a parking aid of the above-mentioned type in that a deflection means is provided for pivoting the sensor and/or the radiation direction of the sensor in dependence on the emitted and/or received signals. Such a deflecting means can pivot the radiation direction or the entire sensor in the direction in which e.g. an object is detected that is located in the detecting region of the sensor. Pivoting of the sensor and/or its radiation direction facilitates detection of this object. The contour of the object may thereby be determined with higher precision compared to conventional parking aids.

In accordance with the invention, the sensor may be pivoted in dependence on the emitted and/or received signals while the vehicle passes an object, such that it remains directed onto the detected object for a maximum time period while the vehicle is moving.

In accordance with the invention, an evaluation unit may be provided to drive the deflection means. The evaluation unit which processes the emitted and/or received signals and detects e.g. the respective distance between the vehicle and an object detected in the detecting region of the sensor, then correspondingly drives the deflection means e.g. on the basis of the respective distance between the object and the vehicle.

The deflecting means may additionally or alternatively be driven in dependence on the traveled path of the vehicle and/or the speed of the vehicle. When the vehicle travels fast, the sensor or its radiation direction must pivot with a corresponding higher speed in order to precisely detect an object or the contour of the object present in the detecting region of the sensor.

In accordance with the invention, the sensor may be pivoted by the deflection means about an axis extending perpendicularly and/or parallel to the direction of travel of the vehicle. With particular preference, it is pivoted about an axis extending perpendicularly to the travelling direction of the vehicle, and extending substantially vertically. The sensor can then be pivoted at least to a limited degree in the travelling direction and/or at least to a limited degree opposite to the travelling direction. Objects that the vehicle has passed, can advantageously be detected by pivoting the sensor opposite to the direction of travel. Objects that the vehicle is approaching can be precisely detected by pivoting the sensor in the direction of travel.

The deflecting means may thereby be able to pivot the sensor or its radiation direction from a neutral position which is, in particular, perpendicular to the direction of travel of the vehicle, into a deflected position which is +/−45° and, in particular, +/−90° from the neutral position. The pivot motion from the neutral position into the deflected position may thereby be performed continuously or in steps. In a particularly simple embodiment of the invention, the sensor may be pivotable only in the neutral position and into the pivoted position in more complex embodiments of the invention, the sensor or its radiation direction can be pivoted continuously in dependence on the received and/or emitted signals, i.e. in particular in dependence on the surface of the object to be detected.

A particularly preferred parking aid is characterized in that the contours of mutually facing ends of two objects that delimit a parking space, can be determined through pivoting the sensor, wherein the length of the parking space can be determined by the separation between the contours of the two objects. The length of the parking space may additionally be determined by the distance that the vehicle has traveled, the speed of the vehicle and/or steering angle of the vehicle.

A position encoder is thereby advantageously provided to determine the traveled path when a speed sensor is provided to determine the speed of the vehicle and/or when a steering angle sensor is provided to determine the steering angle of the vehicle. In particular, when the vehicle does not move along a straight line but along a curved path, a corresponding correction computation can be performed via the steering angle sensor or the steering angle of the vehicle during determination of the contour of the surface of the respective object and/or length of the parking space.

The above-mentioned object is also achieved by a parking aid method for a vehicle which may be particularly suitable for operating an inventive parking aid. In a parking aid method of this type, at least one sensor that emits and/or receives signals is pivoted in dependence on the signals emitted and/or received by the sensor. The contour of an object detected by the sensor can be exactly detected by this pivoting motion of the sensor.

The sensor may thereby be pivoted, in particular, in dependence on the path traveled by the vehicle, the speed of the vehicle and/or the steering angle of the vehicle.

In a particularly preferred inventive method, the length of a parking space that is delimited by two objects is determined. This method is characterized by the following steps:
a) moving along a first object and detecting the lateral separation between the object and the vehicle;
b) pivoting the sensor at least to a certain degree in the direction of the end of the first object that faces the space and determining the contour of the first object when the end of the first object is detected;
c) when the first object is leaving or has left the detecting region of the sensor, the sensor is pivoted at least to a limited extent in the direction of the expected end of the second object that also delimits the parking space;
d) determining the contour of the end of the second object facing the parking space when the second object is in the detecting region of the sensor;
e) determining the length of the space between the mutually facing ends of the two objects based on their contours and the distance between the objects that the vehicle has traveled.

The end of the first object can be determined in accordance with step a) e.g. by a sudden change in separation. In step c), the second object or its contour can be optimally detected when it enters the detecting region of the sensor.

In accordance with the method comprising steps a) through e), the length of a parking space between two objects can consequently be determined with great precision. This provides a more exact prognosis about whether the vehicle fits into the measured parking space.

In accordance with the invention, the sensor may assume a neutral position prior to step a) and/or after step b), in which the sensor radiates, in particular, substantially perpendicularly to the direction of motion of the vehicle. The sensor can also assume such a neutral position e.g. when the first object is out of the detecting region of the sensor and prior to pivoting in the direction of the expected second object.

Further features and details of the invention can be extracted from the following description which describes and explains the invention in more detail with reference to the embodiment shown in the drawing.

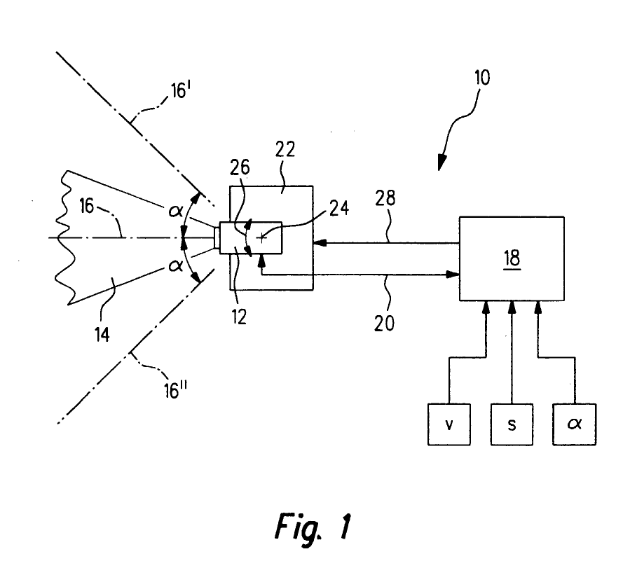

FIG. 1 shows a schematic view of an inventive parking aid;

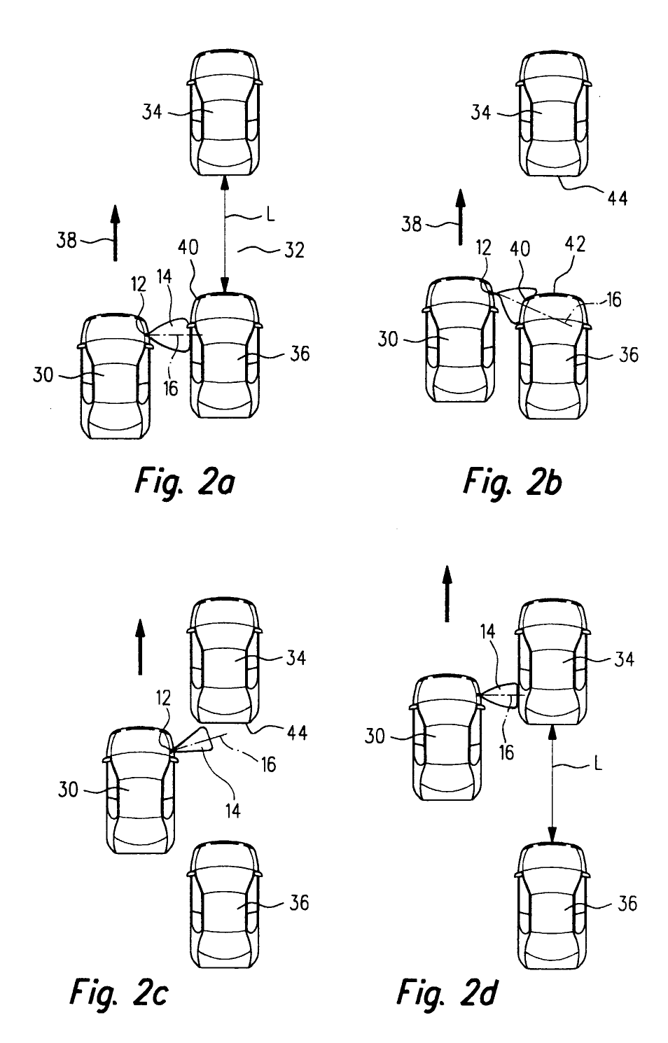

FIGS. 2a, b, c, d show different steps of a parking aid method, wherein the length of a space between two objects is to be determined.

The parking aid, designated in FIG. 1 with 10, for a vehicle comprises a sensor 12 that emits and receives signals, wherein the detecting region of the sensor 12 is indicated by the radiation lobe 14. The axis of the main radiation direction has the reference numeral 16. The sensor 12 may thereby be, in particular, an ultrasound sensor which emits ultrasound signals and receives the ultrasound signals reflected on the objects. The sensor 12 is connected to an evaluation unit 18 via a line 20 to evaluate the emitted and received signals. The line 20 may e.g. be a bus system or part of a bus system. The sensor 12 and the associated evaluation unit 18 can determine, in particular, distances between objects in the detecting region of the sensor.

The parking aid 10 in accordance with the figure also comprises a deflecting means 22 for pivoting the sensor 12 about an axis 24 to at least a limited extent. Pivoting may be effected in the directions of the double arrow 26. In the neutral position of the sensor 12 (FIG. 1), the main radiation direction 16 may e.g. extend largely perpendicularly to the direction of travel of the vehicle. The two maximum deflection positions of the sensor, in which the sensor 12 is pivoted about the axis 24, are indicated by the axes 16′ and 16″ of the respective main radiation directions (FIG. 1). The angle α between the axis 16 and the axes 16′ and 16″ may thereby be in a range of +/−45°. An angle region of +/−20° has proven to be sufficient.

In accordance with the invention, the sensor 12 is pivoted using the deflection means 22 in dependence on the emitted or received signals of the sensor 12. The received signals may thereby be evaluated in the evaluation unit 18 which then correspondingly drives the deflecting means 22 via a line 28.

When e.g. an object is detected in the detecting region of the sensor while passing the object, the sensor 12 may be further directed onto the object via the deflecting means which is driven by the evaluation unit 18 while the vehicle continues to move. The contour of the corresponding object can then be easily detected and determined, since the object remains in the radiation lobe 14 of the sensor 12 for a relatively long time.

The sensor 12 may thereby also be pivoted about the axis 24 in dependence on the speed v of the vehicle, the path s traveled by the vehicle and/or by the respective steering angle α of the vehicle. These parameters can consequently be used as input data of the evaluation unit 18, as is indicated in FIG. 1.

The sensor 12 may thereby also be pivoted about a further axis which extends, in particular, transversely to the axis 24, which may result in a superimposed motion about the two axes.

The inventive parking aid 10 is disposed on the vehicle 30 shown in FIGS. 2a through 2d and serves i.a. to determine the length L of a parking space 32 located between two objects in the form of the two vehicles 34 and 36. In order to determine the length of the parking space 32, the vehicle 30 initially moves in a longitudinal direction past the first vehicle 36 and thereby detects the lateral separation from the vehicle 36 using the sensor 12. The sensor 12 is thereby in the neutral position perpendicular to the travelling direction 38. This is shown in FIG. 2a.

When the corner area 40 of the vehicle 36 is detected based on a detected sudden change in separation, the sensor 12 is pivoted by the deflecting means 22 against the travelling direction towards the end 42 of the vehicle 36 that delimits the space 32. As viewed from above, FIG. 2b shows that in this deflected position, the axis 16 of the main radiation direction extends diagonally towards the rear. The angle between the axis 16 in the neutral position in accordance with FIG. 2a and the deflected position in accordance with FIG. 2b thereby is, in particular, in a range of between 20° and 40°. Pivoting of the sensor 12 in accordance with FIG. 2b permits exact detection of the contour of the end 42 of the vehicle 36.

When the vehicle 30 continues to move in the direction 38 and the vehicle 36 leaves the detecting region 40 of the sensor 12, the sensor 12 is pivoted in the direction in which the rear side 44 of the vehicle 34 that delimits the space 32 is expected. In this deflected position (FIG. 2c) the sensor 12 is consequently pivoted from its neutral position (FIG. 2a) about an angle of approximately 20° to 45° in a diagonal, forward direction. The contour of the rear side 44 of the vehicle 34 can thereby be detected more precisely by the sensor 12 as soon as it enters the detecting region of the sensor 12.

In accordance with FIG. 2d, when the vehicle 30 continues to move in the direction 38, the sensor 12 detects the separation from the parking vehicle 34. The sensor 12 then pivots back into its neutral position.

The length L of the parking space 32 can be determined very exactly from the traveled distance during passing the parking space 32 and the contours of the front side 42 of the vehicle 36 and the rear side 44 of the vehicle 34 that can be exactly detected using the pivotable sensor 12.

The sensor 12 may thereby be continuously pivoted, in particular, in dependence on the speed of the vehicle 30. In accordance with the invention, the sensor 12 may also be pivoted in steps, between its neutral position and the respective deflected positions. Depending on the embodiment of the invention, several intermediate steps may be taken. In a simple embodiment of the invention, there are only three sensor positions, i.e. the neutral position and the two maximally deflected positions.

In accordance with the invention, further sensors may be disposed on the vehicle 30, which are designed like sensor 12, or as non-pivotable sensors.

1-13. (canceled)

14. A parking aid for a vehicle comprising:
at least one sensor that emits and/or receives signals;
an evaluation unit communicating with said sensor to process said emitted and/or received signals; and
a deflecting unit cooperating with said sensor for pivoting said sensor and/or for pivoting a radiation direction of said sensor, in dependence on said emitted and/or received signals.

15. The parking aid of claim 14, wherein said evaluation unit drives said deflecting means.

16. The parking aid of claim 14, wherein said deflecting means is driven in dependence on a distance of a detected object determined by said emitted and/or received signals, a path that the vehicle has traveled, a speed of the vehicle, and/or a steering angle of the vehicle.

17. The parking aid of claim 14, wherein said deflecting means pivot said sensor about an axis which extends perpendicularly and/or parallel to a direction of travel of the vehicle.

18. The parking aid of claim 14, wherein said deflecting means pivot said sensor from a neutral position into a deflection position through +/−45° or through +/−20°.

19. The parking aid of claim 14, wherein a pivot motion is performed gradually or in steps.

20. The parking aid of claim 14, wherein contours of mutually facing ends of two objects that delimit a parking space are determined by pivoting said sensor.

21. The parking aid of claim 14, further comprising a position encoder for determining a traveled path, a speed sensor for determining a speed of the vehicle, and/or a steering angle sensor for determining a steering angle of the vehicle.

22. A method for assisted parking of a vehicle, the method comprising the steps of:
a) emitting and/or receiving signals using at least one sensor;
b) communicating with said sensor using an evaluation unit to process said emitted and/or received signals; and
c) pivoting said sensor and/or pivoting a radiation direction of said sensor using a deflecting unit cooperating with said sensor and in dependence on said emitted and/or received signals.

23. The method of claim 22, wherein said sensor is pivoted in dependence on a path traveled by the vehicle, a speed of the vehicle, and/or a steering angle of the vehicle.

24. The method of claim 23, wherein said sensor is pivoted between a neutral position and a deflected position, either continuously or in steps.

25. The method of claim 22, further comprising the steps of:
d) moving along a first object while detecting a lateral separation between the first object and the vehicle;
e) pivoting said sensor in the direction of an end of the first object that faces a parking space and determining a contour or the end of the first object when the end of the first object is detected;
f) when the first object is leaving or has left a detecting region of said sensor, pivoting said sensor in a direction of an expected end of a second object that also delimits the parking space;
g) determining a contour of the end of the second object facing the parking space when the second object is in the detecting region of said sensor; and
h) determining a length of the parking space between mutually facing ends of the first and second objects based on contours thereof and a distance between the objects that the vehicle has traveled.

26. The method of claim 25, wherein, prior to step d) and/or after step g), the sensor assumes a neutral position in which the sensor radiates or radiates substantially perpendicularly to a direction of travel of the vehicle.
